(19) United States
(12) Patent Application Publication
(10) Pub. No.: US 2012/0105354 A1
(43) Pub. Date: May 3, 2012

(54) Tactile Feedback Cover Lens for a Capacitive Touchscreen System

(75) Inventor: Shar Narasimhan, Mountain View, CA (US)

(73) Assignee: Avago Technologies ECBU IP (Singapore) Pte. Ltd., Fort Collins, CO (US)

(21) Appl. No.: 12/916,563

(22) Filed: Oct. 31, 2010

(51) Int. Cl. G06F 3/045

(52) U.S. Cl. 345/174

(57) ABSTRACT

Disclosed herein are various embodiments of a mobile electronic device and corresponding cover lens therefor. The device comprises a primary capacitive touchscreen or display comprising a primary touch region having principal capacitive touch sensors associated therewith. A cover lens comprising at least a first secondary touch region forms a portion of the device. At least one secondary capacitive touch sensor is associated with the first secondary touch region. The cover lens is disposed and extends over the secondary touch sensor, and the first secondary touch region is spaced apart from the primary touch region and extends over the secondary touch sensor. The first secondary touch region is configured to provide tactile feedback to a user through the user's finger or other pointing device when the user's finger or other pointing device is placed on or moved across the first secondary touch region. The first secondary touch region of the cover lens further has a thickness sufficiently small to permit detection of the user's finger or other pointing device therethrough by the secondary sensor when the user's finger or other pointing device is in physical contact with the first secondary touch region and placed thereon or moved thereacross.

### FIELD OF THE INVENTION

Various embodiments of the invention described herein relate to the field of capacitive sensing input devices generally, and more specifically to cover lenses for such input devices. The input devices may be incorporated into and form a portion of mobile electronic devices and other types of electronic devices.

### BACKGROUND

Two principal capacitive sensing and measurement technologies are currently employed in most touchpad and touchscreen devices. The first such technology is that of self-capacitance. Many devices manufactured by SYNAPTICS™ employ self-capacitance measurement techniques, as do integrated circuit (IC) devices such as the CYPRESS PSOC.™ Self-capacitance involves measuring the self-capacitance of a series of electrode pads using techniques such as those described in U.S. Pat. No. 5,543,588 to Bisset et al. entitled “Touch Pad Driven Handheld Computing Device” dated Aug. 6, 1996.

Self-capacitance may be measured through the detection of the amount of charge accumulated on an object held at a given voltage (Q=CV). Self-capacitance is typically measured by applying a known voltage to an electrode, and then using a circuit to measure how much charge flows to that same electrode. When external objects are brought close to the electrode, additional charge is attracted to the electrode. As a result, the self-capacitance of the electrode increases. Many touch sensors are configured such That the grounded object is a finger. The human body is essentially a capacitor to a surface where the electric field vanishes, and typically has a capacitance of around 100 pF.

Electrodes in self-capacitance touchpads are typically arranged in rows and columns. By scanning first rows and then columns the locations of individual disturbances induced by the presence of a finger, for example, can be determined. To effect accurate multi-touch measurements in a touchpad, however, it may be required that several finger touches be measured simultaneously. In such a case, row and column techniques for self-capacitance measurement can lead to inconclusive results.

One way in which the number of electrodes can be reduced in a self-capacitance system is by interleaving the electrodes in a saw-tooth pattern. Such interleaving creates a larger region where a finger is sensed by a limited number of adjacent electrodes allowing better interpolation, and therefore fewer electrodes. Such patterns can be particularly effective in one dimensional sensors, such as those employed in IPOD click-wheels. See, for example, U.S. Pat. No. 6,879,930 to Sinclair et al. entitled Capacitance touch slider dated Apr. 12, 2005.

The second primary capacitive sensing and measurement technology employed in touchpad and touchscreen devices is that of mutual capacitance, where measurements are performed using a crossed grid of electrodes. See, for example, U.S. Pat. No. 5,861,875 to Gerpheide entitled “Methods and Apparatus for Data Input “dated Jan. 19, 1999. Mutual capacitance technology is employed in touchpad devices manufactured by CIRQUE.™ In mutual capacitance measurement, capacitance is measured between two conductors, as opposed to a self-capacitance measurement in which the capacitance of a single conductor is measured, and which may be affected by other objects in proximity thereto.

In some mutual capacitance measurement systems, an array of sense electrodes is disposed on a first side of a substrate and an array of drive electrodes is disposed on a second side of the substrate that opposes the first side, a column or row of electrodes in the drive electrode array is driven to a particular voltage, the mutual capacitance to a single row (or column) of the sense electrode array is measured, and the capacitance at a single row-column intersection is determined. By scanning all the rows and columns a map of capacitance measurements may be created for all the nodes in the grid. When a user's finger or other electrically conductive object approaches a given grid point, some of the electric field lines emanating from or near the grid point are deflected, thereby decreasing the mutual capacitance of the two electrodes at the grid point. Because each measurement probes only a single grid intersection point, no measurement ambiguities arise with multiple touches as in the case of some self-capacitance systems. Moreover, it is possible to measure a grid of m×n intersections with only m+n pins on an IC.

Many capacitive touchscreens do not provide tactile feedback to a user, and require the user to look at the touchscreen during operation.

What is needed are devices and methods for providing tactile feedback to a user of a capacitive touchscreen so that the user may operate at least portions of the touchscreen without having to look at the touchscreen.

### SUMMARY

In one embodiment, there is provided a mobile electronic device comprising a primary capacitive touchscreen or display comprising a primary touch region having principal capacitive touch sensors associated therewith, a cover lens comprising at least a first secondary touch region forming a portion thereof, and at least one secondary capacitive touch sensor associated with the first secondary touch region, wherein the cover lens is disposed and extends over the secondary touch sensor, the first secondary touch region is spaced apart from the primary touch region and extends over the secondary touch sensor, and the first secondary touch region is configured to provide tactile feedback to a user through the user's finger or other pointing device when the user's finger or other pointing device is placed on or moved across the first secondary touch region, the first secondary touch region of the cover lens further having a thickness sufficiently small to permit detection of the user's finger or other pointing device therethrough by the secondary sensor when the user's finger or other pointing device is in physical contact with the first secondary touch region and placed thereon or moved thereacross.

In another embodiment, there is provided a cover lens for a mobile electronic device comprising a primary capacitive touchscreen or display comprising a primary touch region having principal capacitive touch sensors associated therewith, a cover lens comprising at least one first secondary touch region forming a portion thereof, and at least one secondary capacitive touch sensor associated with the first secondary touch region, wherein the cover lens is disposed and extends over the first secondary touch sensor, the first secondary touch region is spaced apart from the primary touch region and extends over the secondary touch sensor, and the first secondary touch region is configured to provide tactile feedback to a user through the user's finger or other pointing device when the user's finger or other pointing device is placed on or moved across the first secondary touch region, the first secondary touch region of the cover lens further having a thickness sufficiently small to permit detection of the user's finger or other pointing device therethrough by the secondary sensor when the user's finger or other pointing device is in physical contact with the first secondary touch region and placed thereon or moved thereacross.

In yet another embodiment, there is provided method of detecting a touch on a secondary touch region of a cover lens in a mobile electronic device, the mobile electronic device comprising a primary capacitive touchscreen or display with a primary touch region having principal capacitive touch sensors associated therewith, the cover lens comprising the secondary touch region forming a portion of the cover lens, at least one secondary capacitive touch sensor being associated with the secondary touch region, the cover lens being disposed and extending over the secondary touch sensor, the secondary touch region being spaced apart from the primary touch region and extending over the secondary touch sensor, the secondary touch region being configured to provide tactile feedback to a user through the user's finger or other pointing device when the user's finger or other pointing device is placed on or moved across the secondary touch region, the secondary touch region further having a thickness sufficiently small to permit detection of the user's finger or other pointing device therethrough by the secondary sensor when the user's finger or other pointing device is in physical contact with the secondary touch region and placed thereon or moved thereacross, the method comprising sensing, with the secondary capacitive touch sensor, a touch of the user's finger or other pointing device on the secondary touch region, and reporting the touch to a controller.

Further embodiments are disclosed herein or will become apparent to those skilled in the art after having read and understood the specification and drawings hereof.

### BRIEF DESCRIPTION OF THE DRAWINGS

Different aspects of the various embodiments of the invention will become apparent from the following specification, drawings and claims in which:

FIG. 1 shows a cross-sectional view of one embodiment of a capacitive touchscreen system;

FIG. 2 shows a block diagram of a capacitive touchscreen controller;

FIG. 3 shows one embodiment of a block diagram of a capacitive touchscreen system and a host controller;

FIG. 4 shows a schematic block diagram of one embodiment of a capacitive touchscreen system;

FIG. 5 shows a prior art mobile electronic device;

FIG. 6 shows a top perspective view of one embodiment of a mobile electronic device and a corresponding cover lens;

FIGS. 7 and 8 show cross-sectional views of the mobile electronic device and cover lens of FIG. 6;

FIG. 9 shows a top perspective view of another embodiment of a mobile electronic device and a corresponding cover lens;

FIG. 10 shows a cross-sectional view of the mobile electronic device and cover lens of FIG. 8;

FIG. 11 shows a top perspective view of yet another embodiment of a mobile electronic device and a corresponding cover lens;

FIG. 12 shows a top perspective view of one embodiment of a cover lens;

FIG. 13 shows a cross-sectional view of the cover lens of FIG. 12;

FIGS. 14 and 15 illustrate one embodiment of a method of detecting a touch or tap gesture on a secondary touch region of a cover lens disposed over a mobile electronic device, and

FIG. 16 shows one embodiment of a flowchart corresponding to the methods of FIGS. 14 and 15.

The drawings are not necessarily to scale. Like numbers refer to like parts or steps throughout the drawings.

### DETAILED DESCRIPTIONS OF SOME EMBODIMENTS

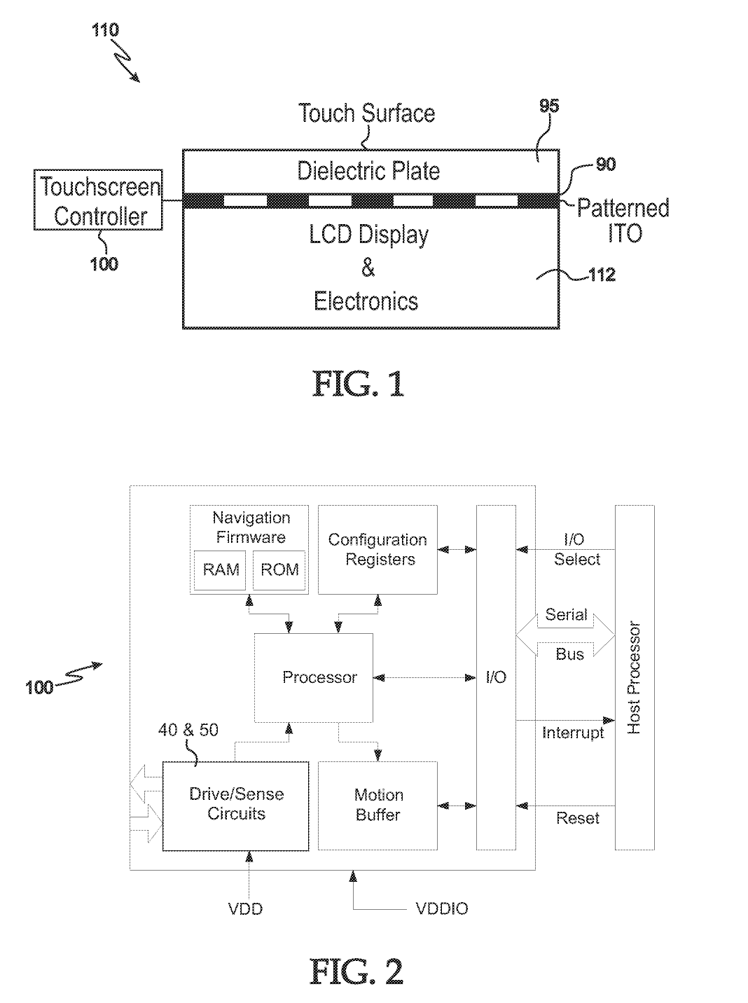

As illustrated in FIG. 1, a capacitive touchscreen system 110 typically consists of an underlying LCD or OLED display 112, an overlying touch-sensitive panel or touchscreen 90, a protective cover or dielectric plate 95 disposed over the touchscreen 90, and a touchscreen controller, micro-processor, application specific integrated circuit (“ASIC”) or CPU 100. Note that image displays other than LCDs or OLEDs may be disposed beneath touchscreen 90.

FIG. 2 shows a block diagram of one embodiment of a touchscreen controller 100. In one embodiment, touchscreen controller 100 may be an Avago Technologies™ AMRI-5000 ASIC or chip 100 modified in accordance with the teachings presented herein. In one embodiment, touchscreen controller is a low-power capacitive touch-panel controller designed to provide a touchscreen system with high-accuracy, on-screen navigation.

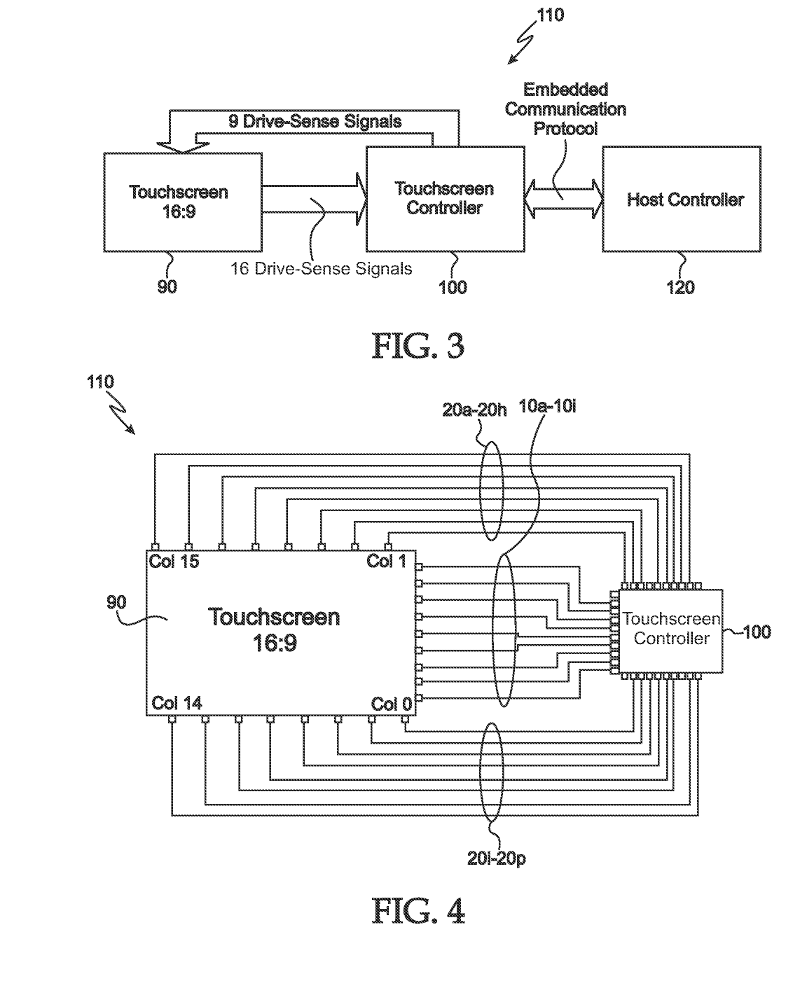

Capacitive touchscreens or touch panels 90 shown in FIGS. 3 and 4 can be formed by applying a conductive material such as Indium Tin Oxide (ITO) to the surface(s) of a dielectric plate, which typically comprises glass, plastic or another suitable electrically insulative and preferably optically transmissive material, and which is usually configured in the shape of an electrode grid. The capacitance of the grid holds an electrical charge, and touching the panel with a finger presents a circuit path to the user's body, which causes a change in the capacitance.

Touchscreen controller 100 senses and analyzes the coordinates of these changes in capacitance. When touchscreen 90 is affixed to a display with a graphical user interface, on-screen navigation is possible by tracking the touch coordinates. Often it is necessary to detect multiple touches. The size of the grid is driven by the desired resolution of the touches. Typically there is an additional cover plate 95 to protect the top ITO layer of touchscreen 90 to form a complete touch screen solution (see, e.g., FIG. 1).

One way to create a touchscreen 90 is to apply an ITO grid on one side only of a dielectric plate or substrate. When the touchscreen 90 is mated with a display there is no need for an additional protective cover. This has the benefit of creating a thinner display system with improved transmissivity (>90%), enabling brighter and lighter handheld devices. Applications for touchscreen controller 100 include, but are not limited to, smart phones, portable media players, mobile internet devices (MIDs), and GPS devices.

Referring now to FIGS. 3 and 4, in one embodiment the touchscreen controller 100 includes an analog front end with 9 sense lines 10a-10i and 16 drive lines 20a-20p connected to an ITO grid on a touchscreen. Touchscreen controller 100 applies an excitation such as a square wave, meander signal or other suitable type of drive signal to the drive electrodes that may have a frequency selected from a range between about 40 kHz and about 200 kHz. The AC signal is coupled to the sense lines via mutual capacitance. Touchscreen panel 90 with a finger disposed thereon alters the capacitance at the location of the touch. Touchscreen controller 100 can resolve and track multiple touches simultaneously. A high refresh rate allows the host to track rapid touches and any additional movements without appreciable delay. The embedded processor filters the data, identifies the touch coordinates and reports them to the host. The embedded firmware can be updated via patch loading. Other numbers of drive and sense lines are of course contemplated, such as 8×12 and 12×20 arrays.

Touchscreen controller 100 can feature multiple operating modes with varying levels of power consumption. In rest mode controller 100 periodically looks for touches at a rate programmed by the rest rate registers. There are multiple rest modes, each with successively lower power consumption. In the absence of a touch for a certain interval controller 100 may automatically shift to the next-lowest power consumption mode. However, as power consumption is reduced the response time to touches typically increases.

According to one embodiment, and as shown in FIG. 4, an ITO grid on the touchscreen 90 comprises rows 20a-20p (or Y lines 1-16) and columns 10a-10i (or X lines 1-9), where rows 20a-20p are operably connected to drive circuits 40 and columns 10a-10i are operably connected to sense circuits 50. One configuration for routing ITO drive and sense lines to touchscreen controller 100 is shown in FIG. 4.

Note that the rows in a touchscreen may be configured to operate as sense lines, and the columns in a touchscreen may be configured to operate as drive lines. Drive lines may also be selectably switched to operate as sense lines, and sense lines may be selectably switched to operate as drive lines under the control of appropriate multiplexing and control circuitry. Moreover, drive and sense lines may be configured in patterns other than rows and columns, or other than orthogonal rows and columns. Those skilled in the art will understand that touchscreen controllers, micro-processors, ASICs or CPUs other than a modified AMRI-5000 chip or touchscreen controller 100 may be employed in touchscreen system 110, and that different numbers of drive and sense lines, and different numbers and configurations of drive and sense electrodes, other than those explicitly shown herein may be employed without departing from the scope or spirit of the various embodiments of the invention.

In one embodiment, the angle between traces 10 and 20 is about 90 degrees (as shown, for example in FIG. 4), but may be any suitable angle such as, by way of example, about 15 degrees, about 30 degrees, about 45 degrees, about 60 degrees, or about 75 degrees. Electrically conductive traces 10 and 20 may be disposed in substantially parallel but vertically-offset first and second planes, respectively, or may be disposed in substantially the same plane. In one embodiment, electrically conductive traces 10 and 20 comprise indium tin oxide (“ITO”), or any other suitable electrically conductive material. A liquid crystal display may be disposed beneath electrically conductive traces 10 and 20, or any other suitable image display. Electrically conductive traces 10 and 20 are preferably disposed on a substrate comprising an electrically insulative material that is substantially optically transparent.

Note that touchscreen system 110 may be incorporated into or form a portion of an LCD, a computer display, a computer, a laptop computer, a notebook computer, an electronic book reader, a personal data assistant (PDA), a mobile telephone, a smart phone, an electronic book reader, a radio, an MP3 player, a portable music player, a stationary device, a television, a stereo, an exercise machine, an industrial control, a control panel, an outdoor control device, a household appliance, or any other suitable electronic device.

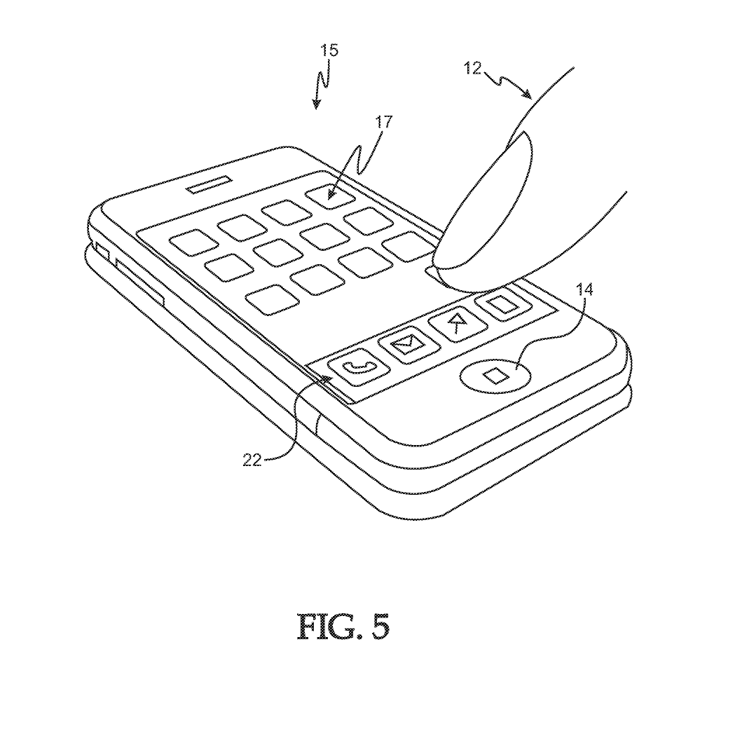

Referring now to FIG. 5, there is shown a prior art mobile electronic device 15 (which in this case is a mobile telephone) having capacitive touchscreen 90 featuring primary touch region 17 and secondary touch region 22, which may comprise one or more hotkeys and home key 18. Mobile electronic device 15, touchscreen 90, primary touch region 17, secondary touch region 22, and home key 14 do not provide tactile feedback to a user, and require the user to look at the touchscreen during operation.

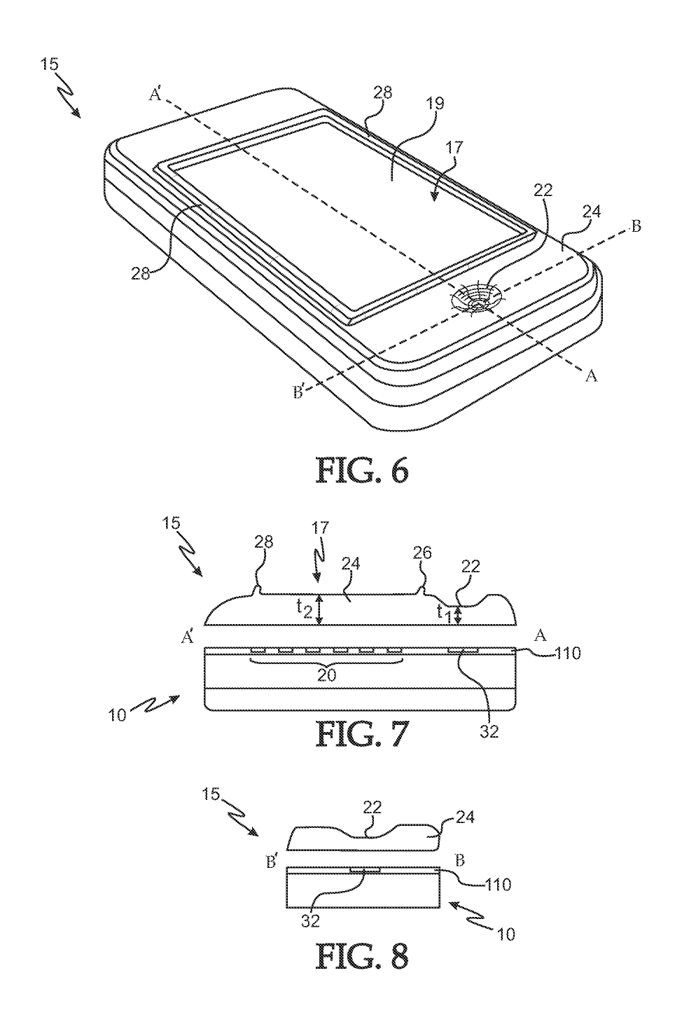

In FIG. 6 there is shown one embodiment of mobile electronic device 15 comprising primary capacitive touchscreen or display 90, which comprises a primary touch region 17 having principal capacitive touch sensors associated therewith. Cover lens 24 is disposed over touchscreen 90 and primary touch region 17 having principal capacitive touch sensors associated therewith, and further comprises at least first secondary touch region 22 forming a portion thereof. At least one secondary capacitive touch sensor (not shown in FIG. 6—see secondary capacitive touch sensor 32 in FIG. 8) is associated with first secondary touch region 22. Cover lens 24 is disposed and extends over secondary touch sensor 32, and first secondary touch region 22 is spaced apart from primary touch region 17 and extends over secondary touch sensor 32. First secondary touch region 22 is configured to provide tactile feedback to a user through the user's finger 12 or other pointing device when the user's finger 12 or other pointing device is placed on or moved across first secondary touch region 22. First secondary touch region 22 of cover lens 24 further has a thickness sufficiently small to permit detection of the user's finger 12 or other pointing device therethrough by secondary capacitive sensor 32 when the user's finger 12 or other pointing device is in physical contact with first secondary touch region 22 and placed thereon or moved thereacross.

FIGS. 7 and 8 display cross-sections along lines A′-A and B′-B of cover lens 24 and mobile electronic device 15 of FIG. 6. FIG. 7 shows drive lines 20 of the primary touchscreen disposed beneath cover lens 24 having a thickness t₂ thereover. Also as shown in FIG. 7, secondary capacitive sensor 32 is separated from a top surface of first secondary touch region 22 by a distance equivalent to thickness t₁ of cover lens 24. Thicknesses t₁ and t₂ must be sufficiently small to permit detection of the user's finger or other pointing device therethrough by sense lines 10 of primary touchscreen 90 and secondary sensor 32 when the user's finger or other pointing device is in physical contact with cover lens 24 in the region disposed over touchscreen 90, or in contact with first secondary touch region 22, and placed thereon or moved thereacross. Cover lens 24 must also be formed of a material that is electrically permissive and does not disrupt the projection of mutual capacitance signals therethrough. Cover lens 24 may have a thickness t₂ ranging between about 0.1 mm and about 3.0 mm, and a thicknesses t₁ between a top surface of the first secondary touch region 22 and the secondary capacitive touch sensor 32 associated therewith ranging between about 0.1 mm and about 3.0 mm. Other thicknesses t₁ and t₂ are also contemplated, such as thicknesses t₁ and/or t₂ ranging between about 0.2 mm and about 2.0 mm, between about 0.3 mm and about 1.5 mm, between about 0.4 mm and about 1.5 mm, between about 0.7 mm and about 1.5 mm, and/or between about 1.0 mm and is about 1.5 mm. It is further contemplated that thicknesses t₁ and t₂ differ from one another. Suitable materials for forming cover lens 24 include, but are not limited to, glass, plastic, Mylar™, polycarbonate, acrylic, polyethylene terephthalate (PET), or suitable combinations of any of the foregoing materials.

As further shown in FIGS. 6, 7 and 8, and in one embodiment, first secondary touch region 22 may comprise a depression or depressed portion of cover lens 24. Alternatively, first secondary touch region 22 may comprise a bump or elevated portion on cover lens 24. FIGS. 7, 8 and 9 show that in one embodiment cover lens 24 extends over at least portions of primary touch region 17. Cover lens 24 is optically transmissive or transparent in region 19 so that the user can see touchscreen 90 beneath cover lens 24.

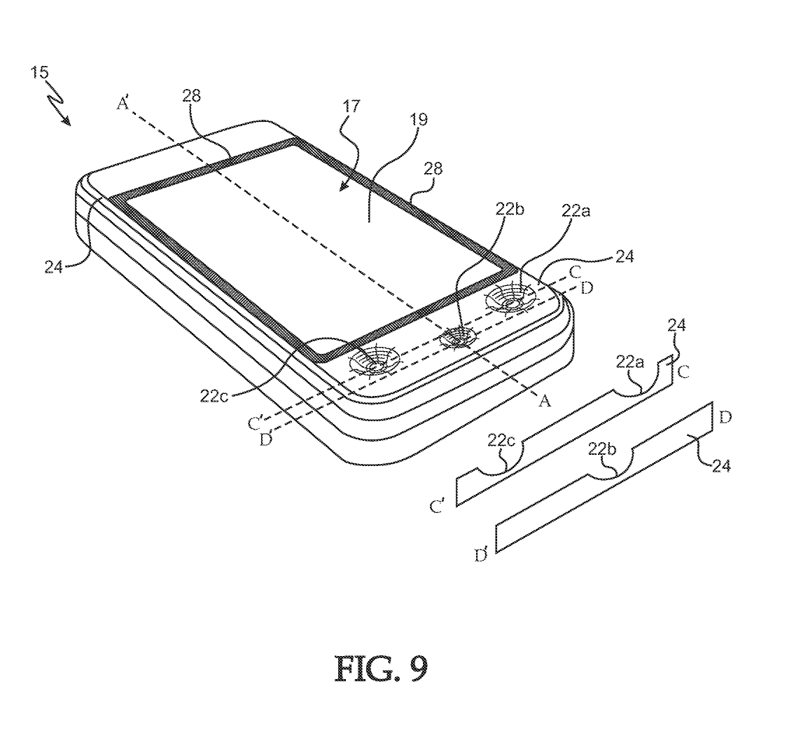

Referring now to FIG. 9, there is shown another embodiment of mobile electronic device 15 having cover lens 24 disposed thereover. In the embodiment shown in FIG. 9, cover lens 24 further comprises a raised or textured edge 28 that is adjacent to or surrounding at least portions of primary touch region 17, where edge 28 is configured to provide tactile feedback to a user passing a finger 12 or other pointing device thereover. In one embodiment, edge 28 separates first secondary touch region 22 from primary touch region 17. Edge 28 may be raised, form a depression or channel, or be textured differently from portions surrounding it to provide increased tactile feedback to the user.

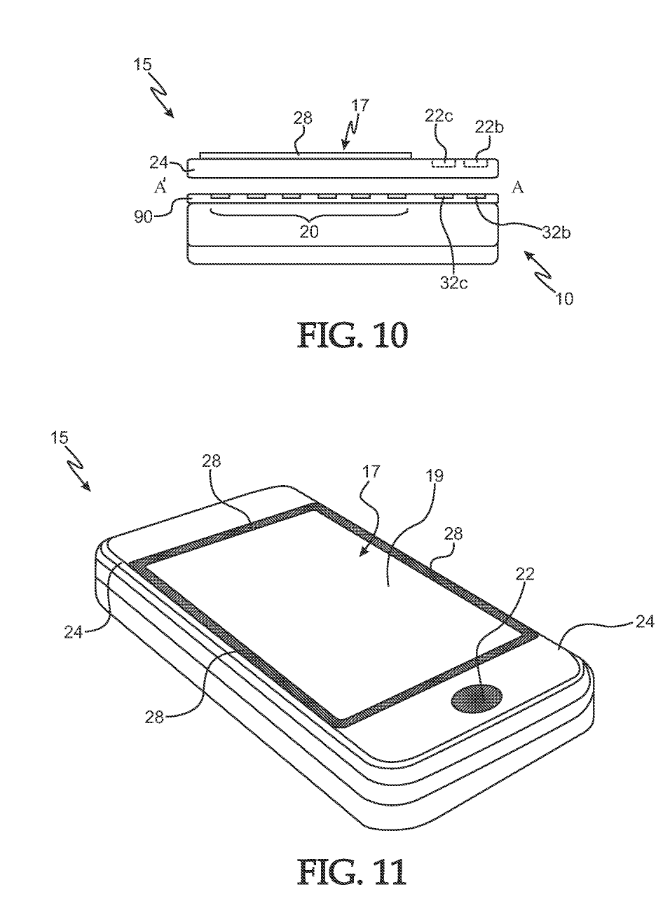

Further as shown in FIG. 9, and as illustrated by cross-sections C′-C and D′-D taken through cover lens 24 (see FIG. 10), a plurality of secondary touch regions 22a, 22b and 22c may be disposed on cover lens 24, and may form one or more of depressions, depressed portions, bumps, or elevated portions on cover lens 24. At least some of the plurality of secondary touch regions 22a, 22b and 22c may be textured differently from portions of the cover lens 24 disposed therearound.

In another embodiment shown in FIG. 11, first secondary touch region 22 may be textured differently from portions of cover lens 24 disposed therearound to provide increased tactile feedback to the user. Edge 28 may also be disposed around at least portions of primary touch area 17 that is textured differently from surrounding portions of cover lens 24 to provide increased tactile feedback to the user.

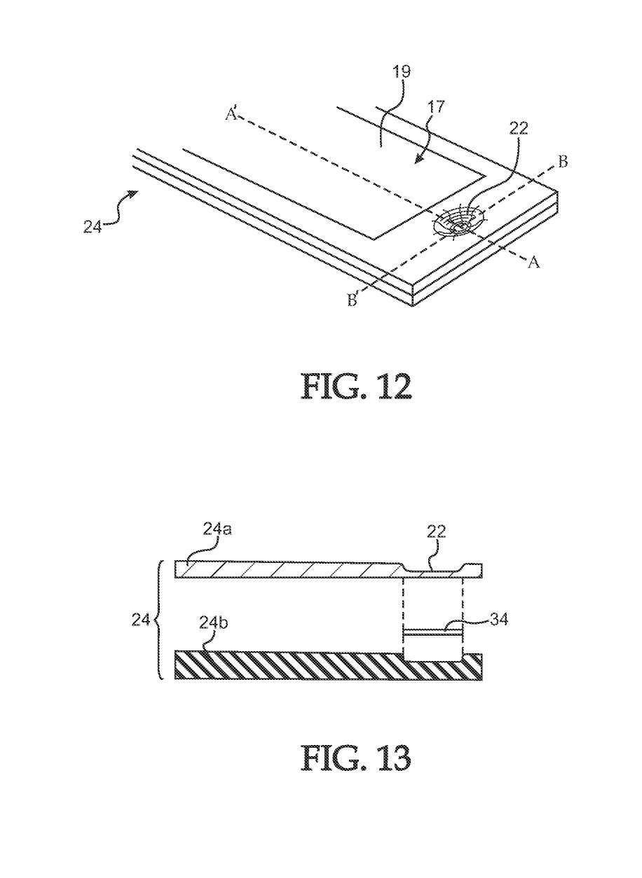

In yet another embodiment shown in FIGS. 12 and 13, cover lens 24 includes a piezoelectric or other type of active feedback actuator 34 disposed beneath secondary touch region 22. In one embodiment, secondary capacitive sensor 32 is disposed beneath piezoelectric other type of active feedback actuator 34, and when a finger 12 or other pointing device is brought into contact with secondary touch region 22 and sensed by secondary capacitive sensor 32, operation of piezoelectric other type of active feedback actuator 34 is triggered, which is felt by the user as a vibrating or shaking sensation imparted through cover lens 24.

Note that in some embodiments cover lens 24 is injection or transfer molded. Individual portions of cover lens 24 such as edge 28, secondary touch region 22, and textured portions thereof, may be formed or treated by embossing, stamping, sandblasting, etching, chemically treating, machining, cutting, or grinding. Textured portions of cover lens 24 may also be formed through the use of textured adhesive labels, patches, or stripes.

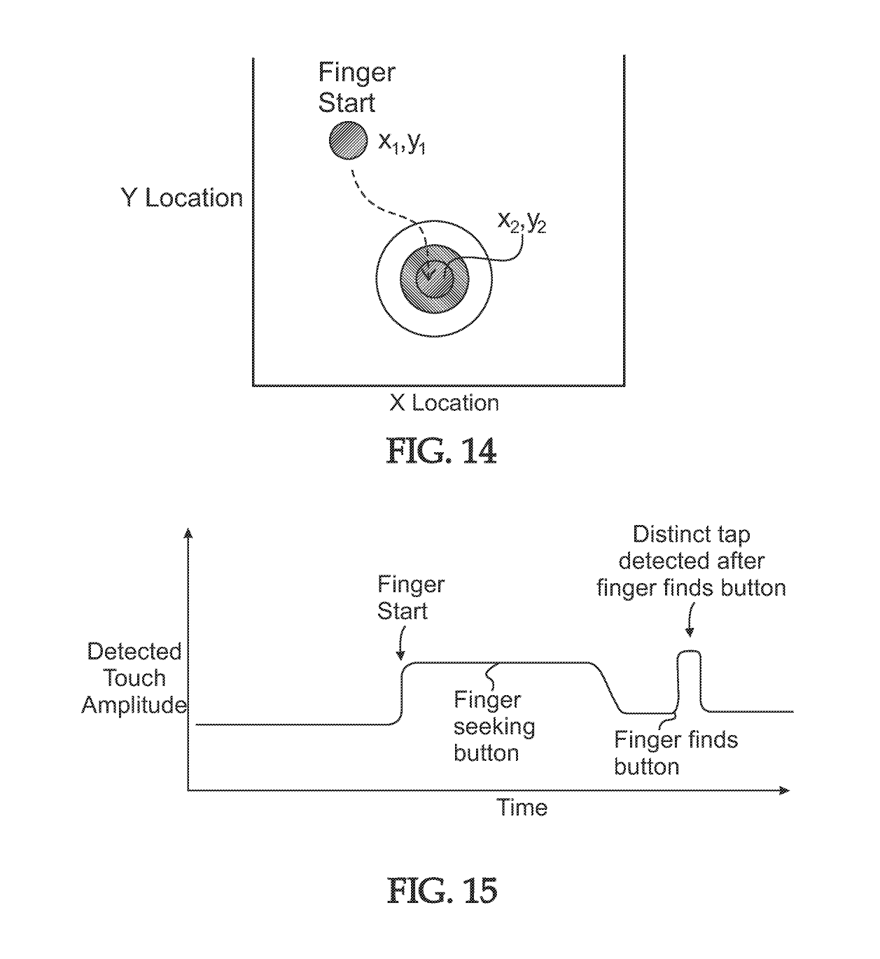

Referring now to FIGS. 14 and 15, there is illustrated one embodiment of a method for detecting a touch or tap in secondary touch region 22. FIG. 14 shows a top plan view of an area surrounding secondary touch region 22, which is designated in FIG. 14 by position x₂,y₂. Finger 12 or other pointing device moves from position x₁,y₁ and upon entering and being in contact with position x₁,y₁ generates a sensed secondary touch. The touch may be a finger or other pointing device merely coming into contact with secondary touch region 22 or constitute a confirmatory finger or other pointing device tap gesture thereon FIG. 15 illustrates the touch signal amplitudes generated by the finger touch profile of FIG. 14.

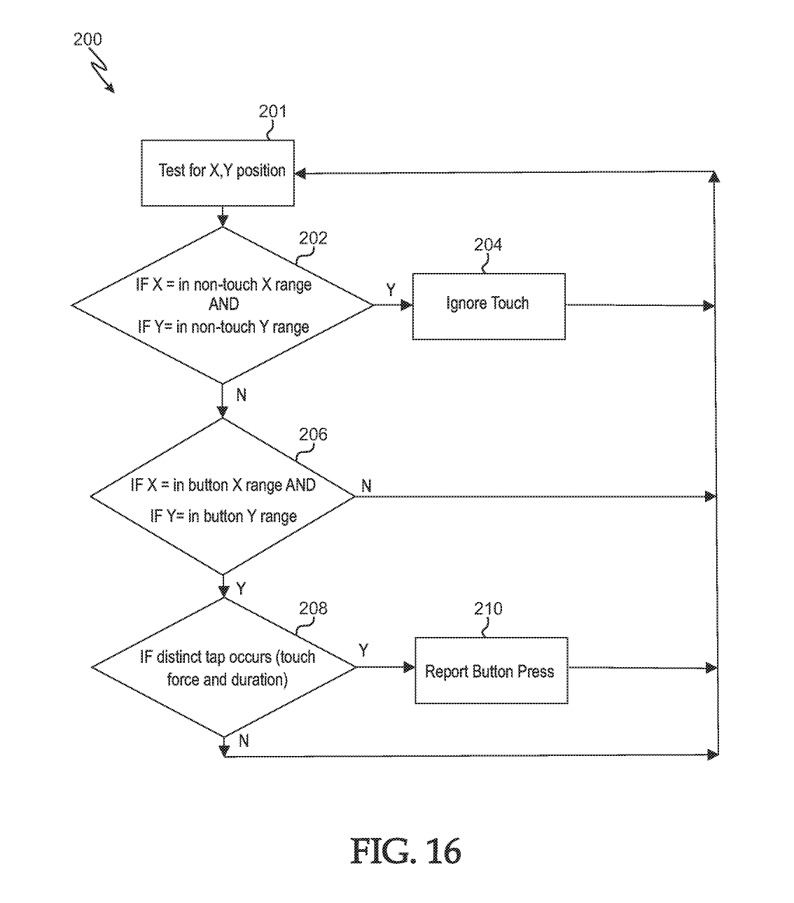

Referring now to FIG. 16, there is shown one embodiment of a flowchart corresponding to the methods of FIGS. 14 and 15. Method 200 illustrated in FIG. 16 comprises detecting and reporting a button press or touch made on secondary touch region 22. In step 201, the x,y position corresponding to secondary touch position 22 is sensed or tested. If no change in x or y range touch signals corresponding to a touch or tap is detected at step 202, the sensing system of device 15 continues scanning the x,y position corresponding to secondary touch position 22 for touches or taps. If a change in x or y range touch signals corresponding to a touch or tap is detected at step 202, the sensing system of device 15 determines whether both of the x and y range touch signals indeed correspond to a touch or tap. If not, the system continues scanning the x,y position corresponding to secondary touch position 22 for touches or taps. If the x and y range touch signals do correspond to a touch or tap, a button press is reported to a touchscreen controller or to a host controller.

In another embodiment, a method of detecting a touch on the secondary touch region 22 of cover lens 24 in mobile electronic device 15 is provided comprising sensing, with the secondary capacitive touch sensor 32, a touch of the user's finger 12 or other pointing device on the secondary touch region 22, and reporting the touch to a controller. The touch may be a tap gesture, a sliding or swiping gesture, or any other suitable gesture.

Note that according to some embodiments, the dielectric constants of cover lens 24 may be varied to compensate for varying thicknesses of cover lens 24. For example, a lower dielectric material or layer may be employed in thinner portions of cover lens 24 to yield the same capacitive signal strength as thicker portions of cover lens 24. Without such variations of dielectric constants in cover lens 24, different touch thresholds may be required in the firmware of touchscreen controller 100 to compensate for variations in capacitive signal strength.

Note further that included within the scope of the present invention are methods of making and having made the various components, devices and systems described herein.

The above-described embodiments should be considered as examples of the present invention, rather than as limiting the scope of the invention. In addition to the foregoing embodiments of the invention, review of the detailed description and accompanying drawings will show that there are other embodiments of the present invention. Accordingly, many combinations, permutations, variations and modifications of the foregoing embodiments of the present invention not set forth explicitly herein will nevertheless fall within the scope of the present invention.

I claim:

1. A mobile electronic device, comprising:
(a) a primary capacitive touchscreen or display comprising a primary touch region having principal capacitive touch sensors associated therewith;
(b) a cover lens comprising at least a first secondary touch region forming a portion thereof, and
(c) at least one secondary capacitive touch sensor associated with the first secondary touch region;
wherein the cover lens is disposed and extends over the secondary touch sensor, the first secondary touch region is spaced apart from the primary touch region and extends over the secondary touch sensor, and the first secondary touch region is configured to provide tactile feedback to a user through the user's finger or other pointing device when the user's finger or other pointing device is placed on or moved across the first secondary touch region, the first secondary touch region of the cover lens further having a thickness sufficiently small to permit detection of the user's finger or other pointing device therethrough by the secondary sensor when the user's finger or other pointing device is in physical contact with the first secondary touch region and placed thereon or moved thereacross.

2. The mobile electronic device of claim 1, wherein the first secondary touch region comprises a depression or depressed portion of the cover lens.

3. The mobile electronic device of claim 1, wherein the first secondary touch region comprises a bump or elevated portion on the cover lens.

4. The mobile electronic device of claim 1, wherein the first secondary touch region is textured differently from portions of the cover lens disposed therearound.

5. The mobile electronic device of claim 1, wherein the cover lens extends over at least portions of the primary touch region.

6. The mobile electronic device of claim 1, wherein the first secondary touch region is one of a plurality of secondary touch regions disposed on the cover lens.

7. The mobile electronic device of claim 6, wherein at least some of the plurality of secondary touch regions comprise a depression or depressed portion of the cover lens.

8. The mobile electronic device of claim 6, wherein at least some of the plurality of secondary touch regions comprise a bump or elevated portion on the cover lens.

9. The mobile electronic device of claim 6, wherein at least some of the plurality of secondary touch regions are textured differently from portions of the cover lens disposed therearound.

10. The mobile electronic device of claim 1, wherein the cover lens extends over at least portions of the primary touch region.

11. The mobile electronic device of claim 10, wherein the cover lens further comprises a raised edge adjacent to or surrounding at least portions of the primary touch region, the edge providing tactile feedback to a user passing a finger or other pointing device thereover.

12. The mobile electronic device of claim 11, wherein the edge separates the first secondary touch region from primary touch region.

13. The mobile electronic device of claim 1, wherein an active feedback actuator is disposed beneath the first secondary touch region, the actuator being configured to provide tactile feedback to a user placing a finger or other pointing device on the first secondary touch region.

14. The mobile electronic device of claim 1, wherein the cover lens is formed of one of glass, plastic, polycarbonate, acrylic, polyethylene terephthalate (PET), or a combination thereof.

15. The mobile electronic device of claim 1, wherein the cover lens has a thickness ranging between about 0.1 mm and about 3.0 mm.

16. The cover lens of claim 20, wherein dielectric constants of the cover lens vary.

17. The mobile electronic device of claim 1, wherein at least portions of the cover lens are optically transparent or optically transmissive.

18. The mobile electronic device of claim 1, wherein the cover lens further comprises an adhesive configured to attach an underside of the cover lens to the mobile electronic device.

19. The mobile electronic device of claim 1, wherein the device is one of a computer, a notebook computer, a laptop computer, a personal data assistant (PDA), a mobile telephone, a smart phone, an electronic book reader, a radio, an MP3 player, and a portable music player.

20. A cover lens for a mobile electronic device, comprising:
(a) a primary capacitive touchscreen or display comprising a primary touch region having principal capacitive touch sensors associated therewith;
(b) a cover lens comprising at least one first secondary touch region forming a portion thereof, and
(c) at least one secondary capacitive touch sensor associated with the first secondary touch region;
wherein the cover lens is disposed and extends over the first secondary touch sensor, the first secondary touch region is spaced apart from the primary touch region and extends over the secondary touch sensor, and the first secondary touch region is configured to provide tactile feedback to a user through the user's finger or other pointing device when the user's finger or other pointing device is placed on or moved across the first secondary touch region, the first secondary touch region of the cover lens further having a thickness sufficiently small to permit detection of the user's finger or other pointing device therethrough by the secondary sensor when the user's finger or other pointing device is in physical contact with the first secondary touch region and placed thereon or moved thereacross.

21. The cover lens of claim 20, wherein the first secondary touch region comprises a depression or depressed portion of the cover lens.

22. The cover lens of claim 20, wherein the first secondary touch region comprises a bump or elevated portion on the cover lens.

23. The cover lens of claim 20, wherein the first secondary touch region is textured differently from portions of the cover lens disposed therearound.

24. The cover lens of claim 20, wherein the cover lens extends over at least portions of the primary touch region.

25. The cover lens of claim 20, wherein the first touch region is one of a plurality of secondary touch regions disposed on the cover lens.

26. The cover lens of claim 20, wherein at least some of the plurality of secondary touch regions comprise a depression or depressed portion of the cover lens.

27. The cover lens of claim 26, wherein at least some of the plurality of secondary touch regions comprise a bump or elevated portion on the cover lens.

28. The cover lens of claim 26, wherein at least some of the plurality of secondary touch regions are textured differently from portions of the cover lens disposed therearound.

29. The cover lens of claim 20, wherein the cover lens extends over at least portions of the primary touch region.

30. The cover lens of claim 20, wherein the cover lens further comprises a raised edge adjacent to or surrounding at least portions of the primary touch region, the edge providing tactile feedback to a user passing a finger or other pointing device thereover.

31. The cover lens of claim 20, wherein the edge separates the first secondary touch region from the primary touch region.

32. The cover lens of claim 20, wherein an active feedback actuator is disposed beneath the first secondary touch region, the actuator being configured to provide tactile feedback to a user placing a finger or other pointing device on the first secondary touch region.

33. The cover lens of claim 20, wherein the cover lens comprises one of glass, plastic, polycarbonate, acrylic, polyethylene terephthalate (PET), or a combination thereof.

34. The cover lens of claim 20, wherein the cover lens has a thickness ranging between about 0.1 mm and about 3.0 mm.

35. The cover lens of claim 20, wherein dielectric constants of the cover lens vary.

36. The cover lens of claim 20, wherein the cover lens has a substrate forming a portion thereof.

37. The cover lens of claim 20, wherein at least portions of the cover lens are optically transparent or optically transmissive.

38. The cover lens of claim 20, wherein the cover lens further comprises an adhesive configured to attach portions thereof to the mobile electronic device.

39. A method of detecting a touch on a secondary touch region of a cover lens in a mobile electronic device, the mobile electronic device comprising a primary capacitive touchscreen or display with a primary touch region having principal capacitive touch sensors associated therewith, the cover lens comprising the secondary touch region forming a portion of the cover lens, at least one secondary capacitive touch sensor being associated with the secondary touch region, the cover lens being disposed and extending over the secondary touch sensor, the secondary touch region being spaced apart from the primary touch region and extending over the secondary touch sensor, the secondary touch region being configured to provide tactile feedback to a user through the user's finger or other pointing device when the user's finger or other pointing device is placed on or moved across the secondary touch region, the secondary touch region further having a thickness sufficiently small to permit detection of the user's finger or other pointing device therethrough by the secondary sensor when the user's finger or other pointing device is in physical contact with the secondary touch region and placed thereon or moved thereacross, the method comprising:
(a) sensing, with the secondary capacitive touch sensor, a touch of the user's finger or other pointing device on the secondary touch region, and
(b) reporting the touch to a controller.

40. The method of claim 39, wherein the touch is a tap gesture.

41. The method of claim 39, wherein the touch is a sliding or swiping gesture.
